(19) United States
(12) Patent Application Publication
(10) Pub. No.: US 2024/0256885 A1
(43) Pub. Date: Aug. 1, 2024

(54) EXPLORATION METHOD BASED ON REWARD DECOMPOSITION IN MULTI-AGENT REINFORCEMENT LEARNING

(71) Applicant: ELECTRONICS AND TELECOMMUNICATIONS RESEARCH INSTITUTE, Daejeon (KR)

(72) Inventors: Byunghyun YOO, Daejeon (KR); Hyun Woo KIM, Daejeon (KR); Hwajeon SONG, Daejeon (KR); Jeongmin YANG, Daejeon (KR); Sungwon YI, Daejeon (KR); Euisok CHUNG, Daejeon (KR); Ran HAN, Daejeon (KR)

(73) Assignee: ELECTRONICS AND TELECOMMUNICATIONS RESEARCH INSTITUTE, Daejeon (KR)

(21) Appl. No.: 18/517,931

(22) Filed: Nov. 22, 2023

(30) Foreign Application Priority Data
Jan. 26, 2023 (KR) 10-2023-0010071

(51) Int. Cl. G06N 3/092

(52) U.S. Cl. CPC G06N 3/092

(57) ABSTRACT

Provided is an exploration method based on reward decomposition in multi-agent reinforcement learning. The exploration method includes: generating a positive reward estimation model through neural network training based on training data including states of all agents, actions of all the agents, and a global reward true value; generating, for each of the agents, a first individual utility function based on the global reward true value and generating a second individual utility function using the positive reward estimation model; and determining an action of each of the agents using the first individual utility function and the second individual utility function based on the state of each of the agents.

### CROSS-REFERENCE TO RELATED APPLICATION

This application claims priority to and the benefit of Korean Patent Application No. 10-2023-0010071, filed on Jan. 26, 2023, the disclosure of which is incorporated herein by reference in its entirety.

### BACKGROUND

### 1. Field of the Invention

The present invention relates to an exploration method in multi-agent reinforcement learning. More specifically, the present invention relates to an exploration method in multi-agent reinforcement learning for collecting efficient training data in a multi-agent environment that provides complex rewards.

### 2. Discussion of Related Art

Multi-agent reinforcement learning is a technique for learning optimal strategies for cooperation or competition between agents in an environment in which two or more agents are present. In particular, cooperative multi-agent reinforcement learning, which aims to search for a cooperative strategy between multiple agents, is a technology that is gaining attention from many research institutes due to applications in various fields, such as autonomous-driving vehicles, unmanned aerial vehicles, and the like. In general, in the existing multi-agent reinforcement learning methods, in order to search for a cooperative strategy, a reward suitable for the goal is set and the reward is shared between all agents. The shared reward is maximized by all the agents, thereby finding a cooperation strategy that suits the goal. The reward shared among all the agents is referred to as a global reward. In practice, the global reward is composed of the sum of various types of local rewards, but in most environments, local rewards are not observed and only a global reward is observed, and thus in general reinforcement learning or multi-agent reinforcement learning, learning is performed using only the global reward.

In multi-agent reinforcement learning, agents select an action in their current states through interaction with the environment, continuously collect the value of the global reward given to the agents from the environment according to the action being selected, and perform learning based on the data. In this case, determining which action is to be selected depending on the state of the agent is referred to as a policy. As a result, the learning goal is to search for a policy that maximizes the cumulative sum of the global rewards. In order to rapidly and accurately search for the optimal policy, it is required for the agent to select an action that is helpful in learning efficiency when collecting data. Efficiently selecting actions by agents to collect data is referred to as an exploration technique. Single-agent reinforcement learning generally uses an epsilon-greedy (c-greedy) technique of learning a value function, which is an expected value of the sum of global rewards, and selecting an action that maximizes the value of the value function, or selecting a random action. In multi-agent reinforcement learning, a joint value function, which is an expected value of the sum of global rewards for all agents, is learned and assigned to each agent. The function assigned to each agent is referred to as an individual utility function, and the function serves a similar role to the value function of each agent. Once the individual utility function is determined, each agent performs exploration based on the individual utility function thereof according to the c-greedy method, similar to the single-agent reinforcement learning. However, the method may operate in various multi-agent environments, but may fail to search for an optimal policy when a complex reward structure is used to learn complex forms of cooperation.

### SUMMARY OF THE INVENTION

The present invention is directed to providing an exploration method in multi-agent reinforcement learning based on reward decomposition that is capable of, in order to search for an optimal policy in a multi-agent environment having a complex reward structure in which positive rewards and negative rewards simultaneously occur, decomposing the global reward into a positive local reward and a negative local reward, learning a value function using the global reward and the positive local reward, and allowing an action to be selected using the learned value function.

The technical objectives of the present invention are not limited to the above, and other objectives that are not described above may become apparent to those of ordinary skill in the art based on the following descriptions.

According to an embodiment of the present invention, there is provided an exploration method based on reward decomposition in multi-agent reinforcement learning, the exploration method including: generating a positive reward estimation model through neural network training based on training data including states of all agents, actions of all the agents, and a global reward true value; generating, for each of the agents, a first individual utility function based on the global reward true value and generating a second individual utility function using the positive reward estimation model; and determining an action of each of the agents using the first individual utility function and the second individual utility function based on the state of each of the agents.

The generating of the positive reward estimation model may include: inputting the state of the agent included in the training data into an encoding neural network to generate a state encoding vector, and inputting the action of the agent included in the training data into the encoding neural network to generate an action encoding vector; inputting the state encoding vector and the action encoding vector into a global reward neural network to generate a global reward estimation value; and training a positive local reward neural network included in the global reward neural network using a loss function based on the global reward estimation value and the global reward true value, to generate the positive reward estimation value.

The generating of the positive reward estimation model may include: inputting the global reward estimation value and the global reward true value into the loss function; and training the positive local reward neural network such that a function value of the loss function is minimized, to generate the positive reward estimation model.

The determining of the action may include: selecting any one of the first individual utility function and the second individual utility function according to a predetermined criterion; and selecting any one of a random action and an action that may maximize a value of the selected individual utility function according to a predetermined criterion based on the state of each of the agents.

The selecting of any one of the first individual utility function and the second individual utility function may include selecting any one of the first individual utility function and the second individual utility function according to a preset probability.

In this case, a probability of selecting the first individual utility function may be set to 1-ζ, and a probability of selecting the second individual utility function is set to ζ. In addition, the probability of selecting the second individual utility function may be initially set to 1 and converge to 0 according to progression of exploration.

The determining of the action may include selecting any one of the random action and the action that may maximize the value of the selected individual utility function according to a preset action selection probability.

In this case, a probability of selecting the random action may be set to ε, and a probability of selecting the action that may maximize the value of the selected individual utility function may be set to 1-ε. In addition, the probability of selecting the random action may be initially set to 1 and converge to 0 according to progression of exploration.

According to another embodiment of the present invention, there is provided a computer system including: a memory in which instructions readable by a computer are stored; and at least one processor implemented to execute the instructions.

The at least one processor may be configured to execute the instructions to: generate a positive reward estimation model through neural network training based on training data including states of all agents, actions of all the agents, and a global reward true value; generate, for each of the agents, a first individual utility function based on the global reward true value and generating a second individual utility function using the positive reward estimation model; and determine an action of each of the agents using the first individual utility function and the second individual utility function based on the state of each of the agents.

The at least one processor may be configured to: input the state of the agent included in the training data into an encoding neural network to generate a state encoding vector, and input the action of the agent included in the training data into the encoding neural network to generate an action encoding vector; input the state encoding vector and the action encoding vector into a global reward neural network to generate a global reward estimation value; and train a positive local reward neural network included in the global reward neural network using a loss function based on the global reward estimation value and the global reward true value, to generate the positive reward estimation value.

The at least one processor may be configured to: input the global reward estimation value and the global reward true value into the loss function; and train the positive local reward neural network such that a function value of the loss function is minimized, to generate the positive reward estimation model.

The at least one processor may be configured to: select any one of the first individual utility function and the second individual utility function according to a predetermined criterion; and select any one of a random action and an action that may maximize a value of the selected individual utility function according to a predetermined criterion based on the state of each of the agents.

The at least one processor may be configured to select any one of the first individual utility function and the second individual utility function according to a preset probability.

In this case, wherein a probability of selecting the first individual utility function may be set to 1-ζ, and a probability of selecting the second individual utility function may be set to ζ, and the probability of selecting the second individual utility function may be set to 1 and converge to 0 according to progression of exploration.

The at least one processor may be configured to select any one of the random action and the action that may maximize the value of the selected individual utility function according to a preset action selection probability.

In this case, a probability of selecting the random action may be set to ε, and a probability of selecting the action that may maximize the value of the selected individual utility function may be set to 1-ε, and the probability of selecting the random action may be initially set to 1 and converges to 0 as exploration progresses.

### BRIEF DESCRIPTION OF THE DRAWINGS

FIG. 1 is a flowchart illustrating an exploration method based on reward decomposition in multi-agent reinforcement learning according to an embodiment of the present invention.

FIG. 2 is a diagram illustrating the configuration of a reward decomposition neural model for decomposing a global reward into a positive reward and a negative reward in an embodiment of the present invention.

FIG. 3 is a diagram illustrating an exploration process of selecting an action using value functions learned with a global reward and a positive local reward in an embodiment of the present invention.

FIG. 4 is a block diagram illustrating an exploration apparatus based on reward decomposition for multi-agent reinforcement learning according to an embodiment of the present invention.

### DETAILED DESCRIPTION OF EXEMPLARY EMBODIMENTS

The present invention relates to an exploration method in multi-agent reinforcement learning, and more specifically, to an exploration method in multi-agent reinforcement learning for collecting efficient training data in a multi-agent environment that provides complex rewards.

Recently, in multi-agent reinforcement learning, in order to search for a more complex form of cooperative strategy, a complex reward structure that provides a positive reward when successful cooperation is performed and a negative reward when an undesirable form of cooperation is performed has been used. The use of such a reward structure is needed to search for a complex form of cooperative strategy, but according to the existing exploration techniques, exploration is performed using a value function trained only with global rewards, making it difficult to accurately evaluate actions of the agents. As a solution to the issues described above, the present invention aims to provide an efficient exploration technique to search for the optimal policy in a multi-agent environment having a complex reward structure in which positive rewards and negative rewards simultaneously occur.

Advantages, features, and ways to achieve them will become readily apparent with reference to the following detailed description of embodiments when considered in conjunction with the accompanying drawings. The present invention is not limited to the embodiments disclosed below, and may be embodied in various forms. The embodiments to be described below are only embodiments provided to complete the disclosure of the present invention, and the present invention is defined only by the scope of the appended claims. Meanwhile, terms used herein are used to aid in the explanation of the present invention and are not intended to limit the scope and spirit of the present invention. It should be understood that the singular forms “a” and “an” also include the plural forms unless the context clearly dictates otherwise. The terms “comprises,” “comprising,” “includes,” and/or “including” used herein specify the presence of stated components, steps, operations and/or elements thereof and do not preclude the presence or addition of one or more other components, steps, operations and/or elements thereof.

In the description of the present invention, when it is determined that a detailed description of known related art unnecessarily obscures the subject matter of the present invention, the detailed description will be omitted. Even when there are parts omitted in the present invention, those skilled in the field of artificial intelligence technology or multi-agent reinforcement learning technology will be able to understand the technical content of the present invention based on known technologies.

Hereinafter, embodiments of the present invention will be described in detail with reference to the accompanying drawings. For better understanding of the present invention, the same reference numerals are used to refer to the same elements throughout the description of the figures.

The present invention proposes an exploration method of decomposing a global reward into a positive reward and a negative reward in a multi-agent environment, in which a positive reward and a negative reward simultaneously occur, to estimate the value of the positive reward and thereby increase the probability of selecting an action given a high positive reward. The exploration method includes an operation of decomposing positive and negative rewards from the global reward, an operation of training value functions with each of the global reward and the positive reward, and an operation of selecting an action based on the trained value functions.

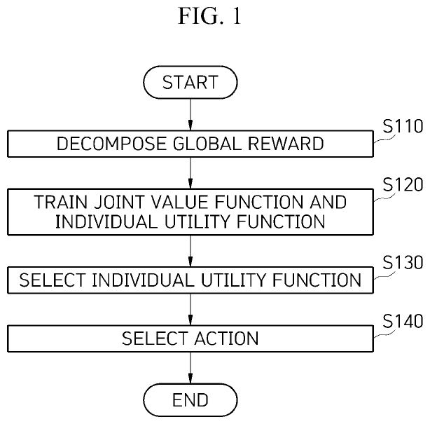

FIG. 1 is a flowchart illustrating an exploration method in multi-agent reinforcement learning based on reward decomposition according to an embodiment of the present invention. The exploration method based on reward decomposition in multi-agent reinforcement learning according to the embodiment of the present invention includes operations S110 to S140.

For convenience of description, it is assumed that the exploration method is performed by an exploration apparatus based on reward decomposition for multi-agent reinforcement learning (hereinafter abbreviated as “exploration apparatus”).

Operation S110 is a global reward decomposition operation. The operation is an operation of decomposing positive and negative rewards from a global reward. In the operation, the exploration apparatus 1000 generates a global reward estimation model and a positive local reward estimation model (hereinafter abbreviated as “positive reward estimation model”) through training of a reward decomposition neural network model based on training data for reward decomposition.

The exploration apparatus 1000 may receive the training data from the outside through a communication device 1020. The training data is composed of current states and current actions of all agents and a global reward true value.

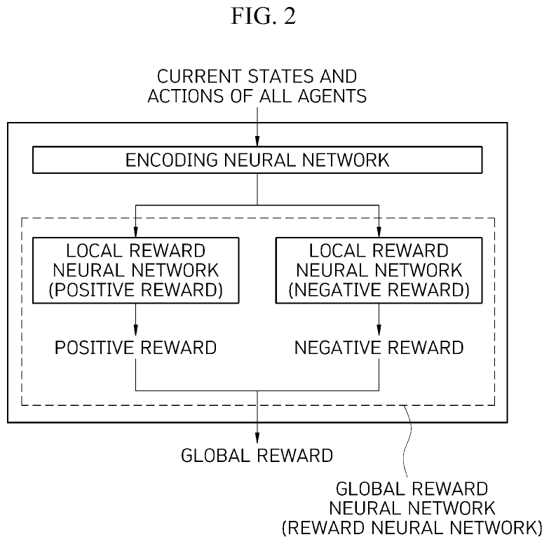

FIG. 2 is a diagram illustrating the configuration of a reward decomposition model for decomposing a global reward into a positive reward and a negative reward in an embodiment of the present invention. The exploration apparatus 1000 converts the current states and the current actions of all the agents included in the training data into a state encoding vector and an action encoding vector through an encoding neural network. That is, the exploration apparatus 1000 inputs the current states of all the agents into the encoding neural network to generate a state encoding vector, and inputs the current actions of all the agents into the encoding neural network to generate an action encoding vector.

The exploration apparatus 1000 inputs the state encoding vector and the action encoding vector into a global reward neural network model. The global reward neural network model (hereinafter also referred to as a “reward decomposition model”) is composed of a positive local reward neural network and a negative local reward neural network. That is, the exploration apparatus 1000 inputs the state encoding vector and the action encoding vector into local reward neural network models that generate positive and negative rewards. The exploration apparatus 1000 summates the positive and negative rewards generated from the respective local reward model, finally generating an estimation value of the global reward (hereinafter referred to as a “global reward estimation value”).

Specifically, the exploration apparatus 1000 inputs the state encoding vector and the action encoding vector into a positive local reward neural network to generate a positive reward estimation value, and inputs the state encoding vector and the action encoding vector into a negative local reward neural network to generate a negative reward estimation value, and summates the positive reward estimation value and the negative reward estimation value to generate a global reward estimation value.

The exploration apparatus 1000 trains the positive reward estimation model based on the global reward values for all states and actions of all agents. The exploration apparatus 1000 trains a global reward neural network included in the reward decomposition model as well as the positive local reward neural network using a predetermined loss function based on the global reward estimation value and the global reward true value, which is a label included in the training data, to generate the global reward estimation model and the positive local reward neural network (hereinafter referred to as a “positive reward estimation model”). Specifically, the exploration apparatus 1000 inputs the global reward estimation value and the global reward true value into the loss function, and trains the global reward neural network and the positive local reward neural network such that a function value of the loss function is minimized, thereby generating the global reward estimation model and the positive reward estimation model.

The loss function for training the reward decomposition model is as shown in Expression 1.

$${\sum }_{k = 1}^{b} {( {r}_{k} - ( {\hat{r}}_{k}^{+} + {\hat{r}}_{k}^{-} ) )}^{2} \qquad [ Expression 1 ]$$

In Expression 1, rₖ is the true value of the global reward, \hat{r}ₖ⁺ is the estimation value of the positive local reward, \hat{r}ₖ⁻ is the estimation value of the negative local reward, and b is the number of pieces of data used for training.

When training a reward decomposition model through Expression 1, there may be various solutions to Expression 1. Therefore, it is common to apply an additional condition to train one accurate reward decomposition model. A representative method is reward decomposition with representation disentanglement (RD2). In RD2, a condition for optimizing the entropy of the reward decomposition model is added, so that when the reward decomposition model is constructed, the amount of information about each local reward model is minimized to reduce unnecessary information in the model, and the amount of information between local reward models is maximized to reduce the amount of duplicate information between local reward models. The present invention is not limited to a specific reward decomposition model, and any reward decomposition model may be used.

Returning to FIG. 1, operation S120 and the subsequent operations will now be described.

Operation S120 is an operation of training a joint value function and an individual utility function. The operation is an operation of training a joint value function with a global reward and a positive reward. The exploration apparatus 1000 generates a global joint value function and a first individual utility function through training based on a global reward true value for all states and actions of all agents. In addition, the exploration apparatus 1000 generates a positive reward joint value function and a second individual utility function through training based on a positive reward estimation value.

The exploration apparatus 1000 may estimate a positive local reward through the reward decomposition model, and the exploration apparatus 1000 may, in addition to a joint value function trained with a global reward in the existing multi-agent reinforcement learning, train an additional joint value function using the positive local reward. The two types of joint value functions trained by the exploration apparatus 1000 with the global reward and the positive local reward are composed as functions of individual utility values for each agent as shown in Expression 2.

$${Q}_{jt} = f ( {Q}_{i} ) , {Q}_{jt}^{+} = {f}^{+} ( {Q}_{i}^{+} ) \qquad [ Expression 2 ]$$

In Expression 2, Qᵢₜ is a joint value function (referred to as a “global joint value function”) trained with the global reward true value, and Qᵢ is an individual utility function (referred to as a “first individual utility function”) for assigning the value of Qⱼₜ to the agent, Qⱼₜ⁺ is a joint value function (referred to as a “positive reward joint value function”) trained with a positive local reward (a positive reward estimation value), and Qᵢ⁺ is an individual utility function (referred to as a “second individual utility function”) for assigning the value of Qⱼₜ⁺ to the agent.

By using the individual utility functions (the first individual utility function and the second individual utility function) calculated through Expression 2, an exploration process (operations S130 and S140) of generating data (training data) to be used for training is performed. For reference, the training data may be composed of the state, the action, and the global reward of each agent.

When many positive and negative local rewards simultaneously occur, and only one of the positive local reward and the negative local reward is large, the evaluation may be sufficiently performable with the global reward value alone. However, for an action in which both the positive and negative rewards are large or both are small, it is difficult to accurately evaluate the action using the global reward alone. Table 1 is a representative example for which it is difficult to accurately evaluate the action using only the global reward.

TABLE

| | Global reward | Positive local reward | Negative local reward |
|---|---|---|---|
| Case 1 | 0 | +3 | −3 |
| Case 2 | 0 | 0 | 0 |

In Table 1, Case 1 and Case 2 both have the same global reward value of 0, but because Case 1 receives a positive local reward, it may be considered that some of the agents select actions that are close to cooperation aimed at a goal. On the other hand, Case 2 is when an action that does not receive any reward is performed. From the perspective of exploration techniques, states such as Case 1 need to be explored before states such as Case 2 such that even some of the agents perform actions related to the cooperation aimed at the goal and data related to the actions related to the cooperation aimed at the goal is collected. For this reason, provided is an exploration technique that maintains a method of using a value function trained using a global reward as in the existing method while selecting an action, in which a value function trained with a positive local reward is high, with a higher probability at the beginning of training.

Operation S130 is an operation of an individual utility function. The operation is an operation in which the exploration apparatus 1000 selects one of the first individual utility function and the second individual utility function according to a predetermined criterion.

Operation S140 is an operation of selecting an action (an operation of determining an action). The operation is an operation of determining an action of the agent using the selected individual utility function based on the state. The exploration apparatus 1000 selects one of an action that maximizes the selected individual utility function value and a random action according to a predetermined criterion based on the state of the agent.

Expression 3 sets probabilities for the first and second individual utility functions to select the individual utility function in operation S130.

$${ψ}_{i} = \{ \begin{matrix}{Q}_{i} ( {s}_{i} , {u}_{i} ) & with prob . 1 - ζ \\ {Q}_{i}^{+} ( {s}_{i} , {u}_{i} ) & with prob . . ζ\end{matrix} \qquad [ Expression 3 ]$$

Expression 4 sets a probability for each action to select one of the action that maximizes the individual utility function value selected in operation S130 and a random action, which is to select an action using an individual utility function in operation S140.

$${u}_{i} = \{ \begin{matrix}{argmax}_{{u}_{i}} {ψ}_{i} ( {s}_{i} , {u}_{i} ) & with prob . 1 - ε \\ a random action & with prob . ε\end{matrix} \qquad [ Expression 4 ]$$

In Expressions 3 and 4, i is an identifier of each agent. uᵢ refers to an action of the agent i. Ψᵢ refers to an individual utility function for agent i, stochastically selected between Qᵢ and Qᵢ⁺.

In Expression 3, ζ is a parameter that determines the probability of selecting two types of value functions. In order to select an action that receives a high positive local reward at the beginning of learning, ζ is set to 1 at the beginning of learning and set to gradually decrease to a value closer to 0 as the learning progresses.

Once an individual utility function is selected, an action that maximizes the individual utility function or a random action is selected, similar to the F-greedy method.

In Expression 4, ε is a parameter that controls selection of an action in the ε-greedy method. ε is set to 1 such that a random action is mainly selected at the beginning of learning and set to gradually decrease to a value close to 0 as learning progresses.

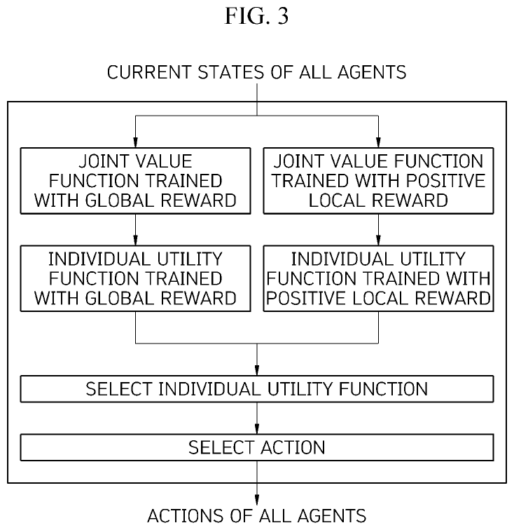

FIG. 3 shows a summary of the above-described content and is a diagram illustrating an exploration process of selecting an action using value functions trained with a global reward and a positive local reward.

A global joint value function is composed of a plurality of first individual utility functions, and the positive reward joint value function is composed of a plurality of second individual utility functions.

When the exploration apparatus 1000 generates a global joint value function through training based on a global reward true value, a first individual utility function is also generated along with the global joint value function. That is, the exploration apparatus 1000 trains the global joint value function and the first individual utility function based on the global reward true value.

In addition, the exploration apparatus 1000 inputs states and actions of all agents into an encoding neural network to generate a state encoding vector and an action encoding vector, and inputs the state encoding vector and the action encoding vector into a positive reward estimation model to generate a positive reward estimation value. When the exploration apparatus 1000 generates a positive reward joint value function through training based on the positive reward estimation value, a second individual utility function is also generated along with the positive reward joint value function. That is, the exploration apparatus 1000 trains the positive reward joint value function and the second individual utility function based on the positive reward estimation value.

When the first individual utility function and the second individual utility function are generated, the exploration apparatus 1000 may perform an exploration process of generating data (training data) which is to be used for learning using the first individual utility function and the second individual utility function. Here, the training data includes data about the states and the actions of all the agents. As presented through Expressions 3 and 4, the exploration apparatus 1000 constructs the training data by selecting one of the first individual utility function (with a probability of 1-ζ) and the second individual utility function (with a probability of ζ) according to a preset utility function selection probability ζ, and selecting one of a random action (with a probability of ε) and an action that maximizes a function value of the selected utility function (with a probability of 1-ε) according to a preset action selection probability ε for a given state of the agent.

The exploration method based on reward decomposition according to an embodiment of the present invention has been described above with reference to the flowcharts presented in the drawings. While the above method has been shown and described as a series of blocks for purposes of simplicity, it is to be understood that the invention is not limited to the order of the blocks, and that some blocks may be executed in different orders from those shown and described herein or concurrently with other blocks, and various other branches, flow paths, and sequences of blocks that achieve the same or similar results may be implemented. In addition, not all illustrated blocks may be required for implementation of the method described herein.

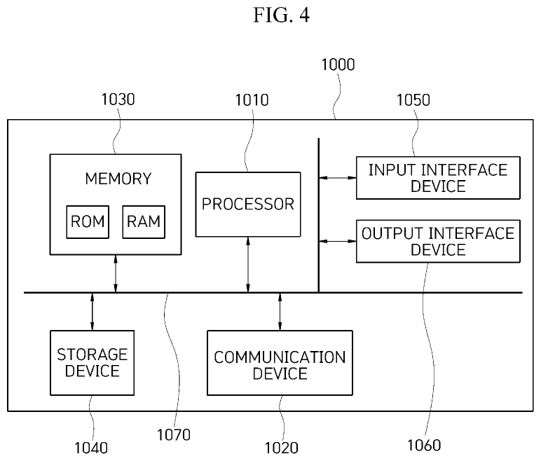

Meanwhile, in the description with reference to FIGS. 1 to 3, each operation may be further divided into a larger number of sub-operations or combined into a smaller number of operations according to examples of implementation of the present invention. In addition, some of the operations may be omitted or may be performed in reverse order as needed. In addition, for parts omitted in the following description with reference to FIG. 4, the description of FIGS. 1 to 3 may be referred to. In addition, the descriptions of FIGS. 1 to 3 may apply to the description of the exploration apparatus 1000 of FIG. 4.

FIG. 4 is a block diagram illustrating an exploration apparatus based on reward decomposition for multi-agent reinforcement learning according to an embodiment of the present invention.

Referring to FIG. 4, an exploration apparatus 1000 based on reward decomposition for multi-agent reinforcement learning (abbreviated as “exploration apparatus”) is an apparatus for performing an exploration method based on reward decomposition in multi-agent reinforcement learning according to the present invention. The exploration apparatus 1000 may be a computer system.

The exploration apparatus 1000 may include at least one of one or more processors 1010, a memory 1030, an input interface device 1050, an output interface device 1060, and a storage device 1040 that communicate through a bus 1070. The exploration apparatus 1000 may further include a communication device 1020 coupled to a wireless or wired network.

The processor 1010 executes the exploration method based on reward decomposition in multi-agent reinforcement learning according to the present invention. That is, the processor 1010 decomposes positive and negative rewards from a global reward, trains a joint value function and an individual utility function with a global reward and a positive reward, selects an individual utility function according to the above-described criteria, and selects an action of each agent using the selected individual utility function based on the state of the agent. Details about the functions of the processor 1010 may be understood by referring to the description referring to FIGS. 1 to 3.

The processor 1010 may be a central processing unit (CPU) or a semiconductor device that executes instructions stored in the memory 1030 or the storage device 1040.

The memory 1030 and the storage device 1040 store computer-readable instructions. In addition, the memory 1030 and the storage device 1040 store training data input to the communication device 1020, a reward decomposition model, a loss function, various types of data (a global reward estimation value, a probability of selecting an individual utility function, and a probability of selecting an action by an agent) generated in a process of the processor 1010 executing the exploration method based on reward decomposition in multi-agent reinforcing learning, and the like.

The processor 1010 is configured to execute the computer-readable instructions stored in the memory 1030 to generate a positive reward estimation model through neural network training based on training data including states of all agents, actions of all agents, and a global reward true value, generate, for each agent, a first individual utility function based on the global reward true value and generate a second individual utility function using the positive reward estimation model, and based on the state of each agent, determine the action of each agent using the first individual utility function and the second individual utility function.

The processor 1010 inputs the state of the agent included in the training data into an encoding neural network to generate a state encoding vector, and inputs the action of the agent included in the training data into the encoding neural network to generate an action encoding vector.

The processor 1010 inputs the state encoding vector and the action encoding vector into a global reward neural network to generate a global reward estimation value.

The processor 1010 is configured to train a positive local reward neural network included in the global reward neural network using a loss function based on the global reward estimation value and the global reward true value to generate the positive reward estimation model.

The processor 1010 is configured to generate the positive reward estimation model by inputting the global reward estimation value and the global reward true value into the loss function and training the positive local reward neural network such that a function value of the loss function is minimized.

The processor 1010 selects one of the first individual utility function and the second individual utility function according to a predetermined criterion. The processor 1010 is configured to select one of a random action and an action that maximizes the selected individual utility function value according to a predetermined criterion, based on the state of each agent.

The processor 1010 may be configured to select one of the first individual utility function and the second individual utility function according to a preset probability. In this case, the probability of selecting the first individual utility function may be set to 1-ζ, and the probability of selecting the second individual utility function may be set to ζ. The probability ζ of selecting the second individual utility function may be initially set to 1 and set to converge to 0 as the exploration process progresses.

The processor 1010 may be configured to select one of a random action and an action that maximizes the selected individual utility function value according to a preset action selection probability. In this case, the probability of selecting a random action may be set to ε, and the probability of selecting the action that maximizes the selected individual utility function value may be set to 1-ε. In addition, the probability of selecting a random action may be initially set to 1 and set to converge to 0 as the exploration process progresses.

The memory 1030 and the storage device 1040 may include various types of volatile or nonvolatile media. For example, the memory 1030 may include a read only memory (ROM) or a random-access memory (RAM). The memory 1030 may be located inside or outside the processor 1010 and may be connected to the processor 1010 through various known devices. The memory 1030 may include various forms of volatile or nonvolatile media, for example, may include a ROM or a RAM.

Accordingly, the present invention may be embodied as a method implemented by a computer or non-transitory computer readable media in which computer executable instructions are stored. According to an embodiment, when executed by a processor, computer readable instructions may perform a method according to at least one aspect of the present disclosure.

The communication device 1020 may transmit or receive a wired signal or a wireless signal. The communication device 1020 may receive training data for generating a local reward estimation model and a positive reward estimation model.

In addition, the method according to the present invention may be implemented in the form of program instructions executable by various computer devices and may be recorded on computer readable media.

The computer readable media may be provided with program instructions, data files, data structures, and the like alone or as a combination thereof. The program instructions stored in the computer readable media may be specially designed and constructed for the purposes of the present invention or may be well-known and available to those having skill in the art of computer software. The computer readable storage media include hardware devices configured to store and execute program instructions. For example, the computer readable storage media include magnetic media such as hard disks, floppy disks, and magnetic tape, optical media such as a compact disc (CD)-ROM and a digital video disk (DVD), magneto-optical media such as floptical disks, a ROM, a RAM, a flash memory, etc. The program instructions include not only machine language code made by a compiler but also high level code that can be used by an interpreter etc., which is executed by a computer.

As is apparent from the above, in a multi-agent environment, unlike a single agent, multiple agents interact with each other, and the reward structure is also therefore complex, and it is difficult to accurately evaluate the actions of the agents simply using the global reward. The present invention evaluates actions by dividing the global reward into a positive local reward and a negative local reward, and thus parts of the actions currently selected by the agent that meet the goal and parts that do not meet the goal are quantitatively evaluated, thereby improving the accuracy of evaluation of actions of the agents. The accurate evaluation of actions helps to efficiently collect data that needs to be collected to search for the optimal policy in an exploration operation, ultimately allowing the optimal policy to be found more rapidly.

The effects of the present invention are not limited to those described above, and other effects that are not described above will be clearly understood by those skilled in the art from the above detailed description.

Although the present invention has been described in detail above with reference to the exemplary embodiments, those of ordinary skill in the technical field to which the present invention pertains should be able to understand that various modifications and alterations may be made without departing from the technical spirit or features of the present invention.

What is claimed is:

1. An exploration method based on reward decomposition in multi-agent reinforcement learning, the exploration method comprising:
generating a positive reward estimation model through neural network training based on training data including states of all agents, actions of all the agents, and a global reward true value;
generating, for each of the agents, a first individual utility function based on the global reward true value and generating a second individual utility function using the positive reward estimation model; and
determining an action of each of the agents using the first individual utility function and the second individual utility function based on the state of each of the agents.

2. The exploration method of claim 1, wherein the generating of the positive reward estimation model includes:
inputting the state of the agent included in the training data into an encoding neural network to generate a state encoding vector, and inputting the action of the agent included in the training data into the encoding neural network to generate an action encoding vector;
inputting the state encoding vector and the action encoding vector into a global reward neural network to generate a global reward estimation value; and
training a positive local reward neural network included in the global reward neural network using a loss function based on the global reward estimation value and the global reward true value, to generate the positive reward estimation value.

3. The exploration method of claim 2, wherein the generating of the positive reward estimation model includes:
inputting the global reward estimation value and the global reward true value into the loss function; and
training the positive local reward neural network such that a function value of the loss function is minimized, to generate the positive reward estimation model.

4. The exploration method of claim 1, wherein the determining of the action includes:
selecting any one of the first individual utility function and the second individual utility function according to a predetermined criterion; and
selecting any one of a random action and an action that maximizes a value of the selected individual utility function according to a predetermined criterion based on the state of each of the agents.

5. The exploration method of claim 4, wherein the selecting of any one of the first individual utility function and the second individual utility function includes selecting any one of the first individual utility function and the second individual utility function according to a preset probability,
wherein a probability of selecting the first individual utility function is set to 1-ζ, and a probability of selecting the second individual utility function is set to ζ, and
the probability of selecting the second individual utility function is initially set to 1 and converges to 0 as exploration progresses.

6. The exploration method of claim 4, wherein the determining of the action includes selecting any one of the random action and the action that maximizes the value of the selected individual utility function according to a preset action selection probability,
wherein a probability of selecting the random action is set to ε, and a probability of selecting the action that maximizes the value of the selected individual utility function is set to 1-ε, and
the probability of selecting the random action is initially set to 1 and converges to 0 as exploration progresses.

7. A computer system comprising:
a memory in which instructions readable by a computer are stored; and
at least one processor implemented to execute the instructions,
wherein the at least one processor is configured to execute the instructions to:
generate a positive reward estimation model through neural network training based on training data including states of all agents, actions of all the agents, and a global reward true value;
generate, for each of the agents, a first individual utility function based on the global reward true value and generating a second individual utility function using the positive reward estimation model; and
determine an action of each of the agents using the first individual utility function and the second individual utility function based on the state of each of the agents.

8. The computer system of claim 7, wherein the at least one processor is configured to:
input the state of the agent included in the training data into an encoding neural network to generate a state encoding vector, and input the action of the agent included in the training data into the encoding neural network to generate an action encoding vector;
input the state encoding vector and the action encoding vector into a global reward neural network to generate a global reward estimation value; and
train a positive local reward neural network included in the global reward neural network using a loss function based on the global reward estimation value and the global reward true value, to generate the positive reward estimation value.

9. The computer system of claim 8, wherein the at least one processor is configured to:
input the global reward estimation value and the global reward true value into the loss function; and
train the positive local reward neural network such that a function value of the loss function is minimized, to generate the positive reward estimation model.

10. The computer system of claim 7, wherein the at least one processor is configured to:
select any one of the first individual utility function and the second individual utility function according to a predetermined criterion; and
select any one of a random action and an action that maximizes a value of the selected individual utility function according to a predetermined criterion based on the state of each of the agents.

11. The computer system of claim 10, wherein the at least one processor is configured to select any one of the first individual utility function and the second individual utility function according to a preset probability,
wherein a probability of selecting the first individual utility function is set to 1-ζ, and a probability of selecting the second individual utility function is set to ζ, and
the probability of selecting the second individual utility function is set to 1 and converges to 0 as exploration progresses.

12. The computer system of claim 10, wherein the at least one processor is configured to select any one of the random action and the action that maximizes the value of the selected individual utility function according to a preset action selection probability,
wherein a probability of selecting the random action is set to ε, and a probability of selecting the action that maximizes the value of the selected individual utility function is set to 1-ε, and
the probability of selecting the random action is initially set to 1 and converges to 0 as exploration progresses.
